(19) United States
(12) Patent Application Publication
(10) Pub. No.: US 2011/0240618 A1
(43) Pub. Date: Oct. 6, 2011

(54) LASER PROCESSING METHOD FOR TRANSPARENT MATERIAL

(75) Inventor: Takahiro Kanda, Tokyo (JP)

(73) Assignee: SUMCO CORPORATION, Tokyo (JP)

(21) Appl. No.: 13/041,124

(22) Filed: Mar. 4, 2011

(30) Foreign Application Priority Data
Apr. 6, 2010 (JP) 2010-088019

(51) Int. Cl. B23K 26/38

(52) U.S. Cl. 219/121.72

(57) ABSTRACT

Laser processing methods are provided that are capable of processing a surface to be processed of a transparent material with a high accuracy even if the transparent material has a rear surface with a large roughness or has defects therein. The laser processing methods for processing a transparent material using a laser light, can include: attaching a laser light absorbing substance having an absorption coefficient for the laser light of 1 μm⁻¹ or more to a surface to be processed of the transparent material, the laser light having an oscillation wavelength in a range of 193 to 11000 nm, and the transparent material having an absorption coefficient for the laser light of 1 cm⁻¹ or lower; and, emitting the laser light from a front surface side of the laser light absorbing substance attached to the transparent material to process the surface to be processed of the transparent material.

### TECHNICAL FIELD

The present invention relates to a laser processing method for a transparent material, and, in particular, to a method of processing a transparent material by using a laser light having an oscillation wavelength in a range of 193 nm to 11000 nm.

### BACKGROUND OF THE INVENTION

Conventionally, as a means for providing a marking on or performing micromachining to a workpiece, a laser etching technique such as a laser ablation and a laser melting method has been known. However, with the laser etching technique for processing the workpiece by utilizing absorption of the laser light by the workpiece, it is difficult to process a transparent material having high light-transmittance.

In view of the problem above, as a method of processing a transparent material by using the laser light, there is proposed a method of selectively processing the transparent material at a high speed by preliminarily emitting a short wavelength laser light having high energy and then performing a laser, etching to the transparent material (see; for example, Japanese Patent Application Laid-open No. 07-256473).

However, in a case of the processing method using the short wavelength laser light, it is necessary to use the short wavelength laser light having high energy, causing energy efficiency to reduce, and hence, such a processing method is not appropriate as a method for processing a large number of transparent materials.

Therefore, as a method capable of processing the transparent material using a laser light in an oscillation wavelength range of about 200 to 530 nm without using the short wavelength laser light having high energy, there is proposed a method of processing a transparent material by, in a state where a fluid substance capable of absorbing a laser light in an oscillation wavelength range of about 200 to 530 nm is brought into contact with a surface to be processed (front surface) of the transparent material, emitting a laser light in an oscillation wavelength range of about 200 to 530 nm from an opposite side of the surface to be processed (i.e. from rear surface side) of the transparent material (Japanese Patent No. 3012926).

However, with the method of processing the transparent material using the fluid substance, the laser light emitted from the surface opposite to the surface to be processed (i.e. from rear surface) passes through the transparent material and reaches the surface to be processed, thereby processing the surface to be processed. Therefore, there was a problem that a highly accurate process cannot be performed when the laser light cannot linearly pass through the transparent material in such a case where roughness of the rear surface of the transparent material is large, or defects, which prevent the transmission of the laser light, such as bubbles or foreign matters (hereinafter, simply referred to as “defect”) exist in the transparent material. More specifically, in the method of processing the transparent material using the fluid substance, a part of the laser light is diffused or absorbed due to the defects in the transparent material for example, and hence, there exists a case where a desired depth cannot be obtained through the process or an undesired portion is unintentionally processed.

In view of the facts described above, an object of the present invention is to provide a laser processing method capable of processing a surface to be processed of a transparent material with a high accuracy even if the transparent material has a rear surface with large roughness, or the transparent material has defects therein.

### SUMMARY OF THE INVENTION

An object of the present invention is to advantageously solve the problem described above, and a laser light processing method for a transparent material according to the present invention is a method of processing a transparent material using a laser light, which includes: attaching a laser light absorbing substance having an absorption coefficient for the laser light of 1 μm⁻¹ or more to a surface to be processed of the transparent material, the laser light having an oscillation wavelength in a range of 193 to 11000 nm, and the transparent material having an absorption coefficient for the laser light of 1 cm⁻¹ or lower; and, emitting the laser light from a front surface side of the laser light absorbing substance attached to the transparent material to process the surface to be processed of the transparent material. It is possible to process the transparent material having the absorption coefficient for the laser light of 1 cm⁻¹ or lower, by attaching the laser light absorbing substance to the surface to be processed of the transparent material, and emitting the laser light having an oscillation wavelength in a range of 193 to 11000 nm at a portion where the laser light absorbing substance is attached, as described above. Further, by emitting the laser light from the front surface side of the laser light absorbing substance, there is no need for the laser light to pass through the transparent material at the time of processing, whereby it is possible to process the surface to be processed of a transparent material with a high accuracy even if the transparent material has a rear surface with a large roughness or has defects therein. Note that the term “absorption coefficient” in the present invention represents an absorption coefficient for the laser light used for the processing, and indicates a value obtained from a value of transmittance of a sample (transparent material or laser light absorbing substance) measured by a spectrophotometer with respect to the laser light as well as a thickness of the sample used in the measurement.

According to the laser processing method for a transparent material of the present invention, the transparent material is preferably formed by quartz, calcium fluoride, silicon carbide, sapphire, alumina or diamond. This is because the transparent material formed by quartz, calcium fluoride, silicon carbide, sapphire, alumina or diamond has a low absorption coefficient for the laser light having an oscillation wavelength in a range of 193 to 11000 nm, and it was difficult for the conventional method to process using the laser light.

Further, according to the laser processing method for a transparent material of the present invention, it is preferable for the laser light absorbing substance to be a colored ink. This is because the colored ink is inexpensive, easily available, and thus, suitable especially as the laser light absorbing substance.

According to a laser processing method for a transparent material of the present invention, it is possible to process a surface to be processed of a transparent material with a high accuracy even if the transparent material has a rear surface with large roughness or has defects therein.

### BRIEF DESCRIPTION OF THE DRAWINGS

FIG. 1 is a diagram for explaining an example of a laser processing method for a transparent material according to the present invention, wherein FIG. 1(a) is a diagram illustrating a state where a laser light is emitted onto a transparent material, and FIG. 1(b) is a diagram illustrating a state of the transparent material after the processing.

FIG. 2 is a diagram for explaining another example of a laser light processing method for a transparent material according to the present invention, wherein FIG. 2(a) is a diagram illustrating a state where a laser light is emitted onto a transparent material, and FIG. 2(b) is a diagram illustrating a state of the transparent material after the processing.

FIG. 3 is a diagram for explaining the other example of the laser processing method for a transparent material according to the present invention, wherein FIG. 3(a) is a diagram illustrating a state where a laser light is emitted onto a transparent material, and FIG. 3(b) is a diagram illustrating a state of the transparent material after the processing.

FIG. 4 is a diagram for illustrating a laser processing method for a transparent material of a comparative example, wherein FIG. 4(a) is a diagram illustrating a state where a laser light is emitted onto a transparent material, and FIG. 4(b) is a diagram illustrating a state of the transparent material after the processing.

FIG. 5 is a diagram for illustrating a laser processing method for a transparent material of a comparative example, wherein FIG. 5(a) is a diagram illustrating a state where a laser light is emitted onto a transparent material, and FIG. 5(b) is a diagram illustrating a state of the transparent material after the processing.

### DETAILED DESCRIPTION

Hereinbelow, an embodiment of the present invention will be described with reference to the drawings. A laser processing method for a transparent material according to the present invention is a method of processing a transparent material serving as a workpiece using a laser light, and is applicable, for example, to a laser marking for providing a mark for identification to a transparent substrate as the transparent material, but is not limited to this.

In one example of the laser processing method for the transparent material according to the present invention, as illustrated in FIG. 1(a), first, a laser light absorbing substance 3 corresponding to an oscillation wavelength of a laser light used for the process is applied to a surface 2A to be processed of a transparent material 1A (step of attaching a laser light absorbing substance). Note that, in the laser processing method for a transparent material according to the present invention, a means for attaching the laser light absorbing substance on the transparent material is not limited to application as described above, and it may be possible to attach the laser light absorbing substance on the transparent material by using a known method.

The transparent material 1A processed by the laser processing method for a transparent material according to the present invention includes a transparent material in which an absorption coefficient for a laser light having wavelength in a range of 193 to 11000 nm and used in processing is 1 cm⁻¹ or lower, such as a material formed by quartz, calcium fluoride, silicon carbide, sapphire, alumina or diamond, more specifically, quartz crystal, quartz glass, silicon carbide substrate, sapphire substrate, alumina substrate or diamond substrate.

Further, the laser light absorbing substance 3 includes a substance whose absorption coefficient for a laser light used in processing is 1 μm⁻¹ or more, such as a colored ink including a red ink, green ink, blue ink and black ink, colored paint, or colored liquid including a coloring material. More specifically, as the laser light absorbing substance 3, a red ink may be used in a case where the oscillation wavelength of the laser light for use in processing is in a range of 200 to 500 nm, and a green or blue ink may be used in a case where the oscillation wavelength is in a range of 1000 to 10000 nm. Note that the black ink is especially suitable for the laser light absorbing substance 3 because it can be used as the laser light absorbing substance 3 regardless of the oscillation wavelength of the laser light for use in processing.

The colored ink includes an ink prepared by dissolving various dyes in a solvent or diffusing various pigments in the solvent medium, and adding co-solvent (dissolution auxiliary agent) or resin as needed. Further, as a dye or pigment for the red ink, colcothar or the like may be used; as a dye or pigment for the green ink, a phthalocyanine green, nitroso compound or the like may be used; as a dye or pigment for the blue ink, phthalocyanine blue, anthraquinone or the like may be used; and, as a dye or pigment for the black ink, nigrosine, C. I. solvent black 7, carbon black or the like may be used. Further, as the solvent or solvent medium, propylene glycol monomethylether (PM), xylene or the like may be used, and as the co-solvent, fatty acid such as oleic acid may be used.

It should be noted that, in order to precisely attach the colored ink at a desired processing position and to prevent the colored ink from splashing, it is preferable for the colored ink to have a quick-drying property, and to dry within 10 seconds after application to the transparent material. The quick-drying property of the colored ink can be controlled by adjusting the amount of solvent or solvent medium used, and for example, the quick-drying colored ink can be prepared with a compounding ratio of: 1-15 mass % of dye, 60 mass % or more of solvent, 1-15 mass % of fatty acid, and 1-15 mass % of resin.

Further, in the step of attaching a laser light absorbing substance, it is preferable that a thickness of the laser light absorbing substance 3 applied to the surface 2A to be processed of the transparent material 1A is in a range of 1 to 15 μm, and more preferably, in a range of 8 to 12 μm in order to cause the laser light absorbing substance 3 to sufficiently absorb the laser light to precisely implement the process. This is because, in a case where the application thickness is undesirably thin, the amount of the laser light absorbed by the laser light absorbing substance may be insufficient, and, on the other hand, in a case where the application thickness is undesirably thick, the energy loss within the laser light absorbing substance 3 at the time of absorbing the laser light is high, reducing the accuracy of the process. Note that the laser light absorbing substance 3 may be applied to the transparent material 1A with a felt-tip pen, brush or the like, under a given condition such as under a condition of a reduced pressure, a pressurized condition, a condition surrounded by an ambient gas and a heated condition within the range in which the transparent material 1A and the laser light absorbing substance 3 do not change their property. Further, the thickness of the application of the laser light absorbing substance 3 can be controlled by using a known method such as applying the laser light absorbing substance 3 repeatedly to obtain a laminate thereof.

In this example of the laser processing method for the transparent material, after the step of attaching the laser light absorbing substance, a laser light 4 is emitted to the laser light absorbing material 3 applied to the surface 2A to be processed of the transparent material 1A only from the front surface side of the laser light absorbing material 3 (laser processing step), as illustrated in FIG. 1(a).

As the laser light 4, a laser light having the oscillation wavelength in a range of 193 nm to 11000 nm may be employed. Further, as the laser light 4, it is possible to employ a fundamental oscillation wavelength light such as an ArF laser, XeCl laser, YAG laser, YLF laser and CO₂ laser, or a light obtained by converting the fundamental oscillation wavelength light by a nonlinear optical element and the like.

It should be noted that, as the laser light 4, it may be possible to employ any of a laser light consisted of a single beam, a laser light formed by plural beams, a laser light formed by a continuous beam, and a laser light formed by a pulse beam. However, from the viewpoint of simplification of a device used and reduction in cost of generation of the laser light, it is preferable to employ an infrared laser light with a fundamental oscillation wavelength generated by using an excimer laser. Further, from the viewpoint of efficiently processing without causing damages to the transparent material 1A, it is preferable for the intensity of the laser light 4 to be in a range of 0.1 to 10 J/cm²·pulse, and more preferably, in a range of 1 to 5 J/cm²·pulse. This is because, in a case where the intensity of the emitted laser light 4 is undesirably large, there is a possibility that damages occur to the transparent material 1A during the process, and on the other hand, in a case where the intensity is undesirably small, there is a possibility that the laser processing cannot be implemented favorably.

In the example of the laser processing method for the transparent material according to the present invention described above, a recess (or pit) 5 is formed in the surface 2A to be processed of the transparent material 1A during the laser processing step, as illustrated in FIG. 1(b), by converting a light energy of the laser light 4 absorbed by the laser light absorbing substance 3 into a thermal energy, and selectively causing ablation at the emitting position of the laser light 4. Note that, in the example described above, the laser light 4 is emitted from the front surface side of the laser light absorbing substance 3, and there is no need for the laser light 4 to pass through the transparent material 1A, whereby the surface 2A to be processed can be efficiently processed with high accuracy without causing unnecessary damage to the transparent material 1A. Further, a large-sized device is not necessary, because the process can be implemented simply by applying the laser light absorbing substance 3. Incidentally, in FIG. 1(b), the laser light absorbing substance 3 is removed from the surface 2A to be processed of the transparent material 1A. Although mechanism thereof is not clear, it is deemed that this is because the laser light absorbing substance 3 is also removed by ablation in the early stage of emission of the laser light 4, making the surface subjected to the ablation extremely rough; the laser light 4 continues to be absorbed thereafter; and, the ablation continues, causing the process to continue.

The laser processing method for the transparent material according to the present invention is not limited to the example described above. Further, various modifications can be applied to the laser processing method for the transparent material depending on application.

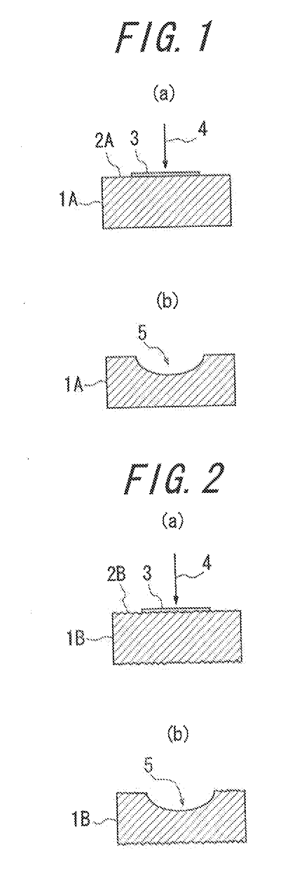

More specifically, the laser processing method for the transparent material according to the present invention may be applied to processing a transparent material having large roughness. For example, as illustrated in FIG. 2(a), the laser processing method for the transparent material according to the present invention may be applied to processing a transparent material 1B having a surface 2B to be processed and a rear surface opposite to the surface 2B to be processed, roughness (center line average roughness: Ra) of which surfaces are 0.4 μm or more.

In a case of processing the transparent material 1B having a large roughness as described above, a part of the laser light 4 is diffused or absorbed on the rear surface of or within the transparent material 1B when the laser light 4 is emitted from the rear surface 8B side opposite to the surface 2B to be processed of the transparent material 1B as illustrated in FIG. 4(a), whereby recesses 7 different from the desired shape and depth are formed in the surface 2B to be processed as illustrated in FIG. 4(b). However, by processing the transparent material 1B in accordance with the laser processing method for the transparent material according to the present invention, it is not necessary for the laser light 4 to pass through the transparent material 1B, whereby the recess 5 can be efficiently formed at a desired position in the surface 2B to be processed in the transparent material 1B with a high accuracy as illustrated in FIG. 2(b). Note that, in FIG. 2 and FIG. 4, the roughness on the front and the rear surfaces of the transparent material 1B is illustrated in an exaggerated manner.

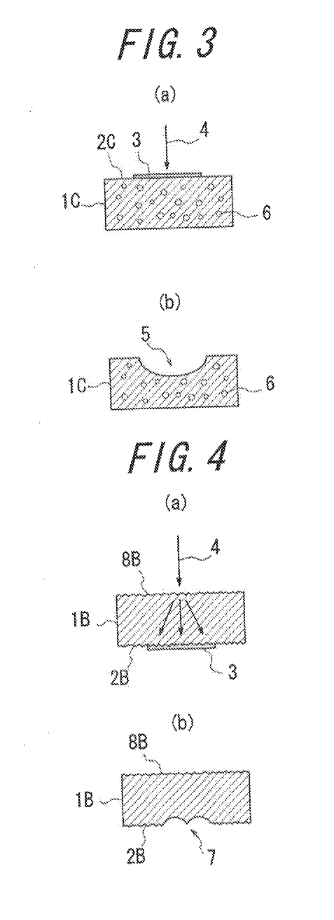

The laser processing method for the transparent material according to the present invention may be applied to processing a transparent material having, inside thereof, crystal-induced defects such as bubbles or foreign matters that may prevent transmission of the laser light 4. For example, as illustrated in FIG. 3(a), the laser processing method for the transparent material according to the present invention may be applied to processing a transparent material 1C having, inside thereof, defects 6 with a diameter of 10 μm or more, preferably, in a range of 10 to 300 in a density of 100000 to 1000000 defects/cm³.

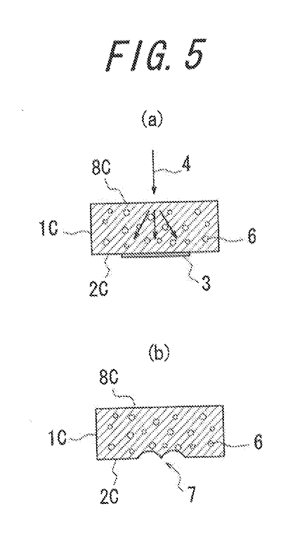

In a case of processing the transparent material 1C having the defects 6 inside thereof, a part of the laser light 4 is diffused or absorbed within the transparent material 1C when the laser light 4 is emitted from the rear surface 8C side opposite to the surface 2C to be processed of the transparent material 1C as illustrated in FIG. 5(a), whereby recesses 7 different from the desired shape and depth are formed in the surface 2C to be processed as illustrated in FIG. 5(b). However, by processing the transparent material 1C in accordance with the laser processing method for the transparent material according to the present invention, it is not necessary for the laser light 4 to pass through the transparent material 1C, whereby the recess 5 can be efficiently formed at a desired position in the surface 2C to be processed in the transparent material 1C with a high accuracy as illustrated in FIG. 3(b). Note that, in FIG. 3 and FIG. 5, the defects in the transparent material 1C is illustrated in an exaggerated manner.

### EXAMPLES

Hereinbelow, the present invention will be described further in detail by using examples. However, the present invention is not limited to the examples described below.

### Example 1

A black ink serving as a laser light absorbing substance prepared by dissolving 120 g of C. I. solvent black 7 with 760 g of propylene glycol monomethylether was applied to a single crystal substrate (Ra: 0.008 μm) made of sapphire as a transparent material, and, from the side where the black ink is applied, an infrared laser light (oscillation wavelength: 1053 nm) was emitted for 20 seconds onto a portion where the black ink is applied under the conditions shown in Table 1. Then, visual check was made as to whether a recess was formed on the single crystal substrate, and a depth and a width of the formed recess were measured with a laser microscope (made by Olympus Corporation). The results are shown in Table 1. Note that the emission condition of the laser was determined such that the recess formed by the laser process has a width of 40 μm and a depth of 100 μm in a case where the ideal laser process is performed. Further, the applied black ink dried immediately after being applied (within one second).

### Example 2

The infrared laser light was emitted as is the case with Example 1, except that the transparent material to be processed was a sapphire single crystal substrate having a front surface Ra of 0.452 μm and a rear surface Ra of 0.443 μm, and the black ink was applied on the front surface. Then, visual check was made as to whether the recess was formed on the single crystal substrate, and the depth and the width of the formed recess were measured with the laser microscope (made by Olympus Corporation). The results are shown in Table 1.

### Example 3

The infrared laser light was emitted as is the case with Example 1, except that the transparent material to be processed was a sapphire single crystal substrate having, inside thereof, bubbles with a diameter of 300 μm or more in a density of 1000000 bubbles/cm³. Then, visual check was made as to whether the recess is formed on the single crystal substrate, and the depth and the width of the formed recess were measured with the laser microscope (made by Olympus Corporation). The results are shown in Table 1.

### Comparative Example 1

The infrared laser light was emitted onto the sapphire single crystal substrate as is the case with Example 1, except that the infrared laser light was emitted only from the side opposite to the side where the black ink was applied. Then, visual check was made as to whether the recess is formed on the single crystal substrate, and the depth and the width of the formed recess were measured with the laser microscope (made by Olympus Corporation). The results are shown in Table 1.

### Comparative Example 2

The infrared laser light was emitted onto the sapphire single crystal substrate as is the case with Example 2, except that the infrared laser light was emitted only from the side opposite to the side where the black ink was applied. Then, visual check was made as to whether the recess was formed on the single crystal substrate, and the depth and the width of the formed recess were measured with the laser microscope (made by Olympus Corporation). The results are shown in Table 1.

### Comparative Example 3

The infrared laser light was emitted onto the sapphire single crystal substrate as is the case with Example 3, except that the infrared laser light was emitted only from the side opposite to the side where the black ink was applied. Then, visual check was made as to whether the recess is formed on the single crystal substrate, and the depth and the width of the formed recess were measured with the laser microscope (made by Olympus Corporation). The results are shown in Table 1.

TABLE 1

| | | Comparative | Comparative | Comparative | | | |
|---|---|---|---|---|---|---|---|
| | | Example 1 | Example 2 | Example 3 | Example 1 | Example 2 | Example 3 |
| Single | Laser light absorption | ≦0.01 | 0.3-0.5 | 0.7-0.9 | ≦0.01 | 0.3-0.5 | 0.7-0.9 |
| crystal | coefficient [cm⁻¹] | | | | | | |
| substrate | Roughness Ra [μm] *1 | 0.008 | 0.443 | 0.008 | 0.008 | 0.452 | 0.008 |
| | Number of bubbles | 0 | 0 | 1000000 | 0 | 0 | 1000000 |
| | [bubbles/cm³] | | | | | | |
| Black ink | Laser light absorption | ≧2.3 | ≧2.3 | ≧2.3 | ≧2.3 | ≧2.3 | ≧2.3 |
| | coefficient [μm⁻¹] | | | | | | |
| | Application thickness | 10 | 10 | 10 | 10 | 10 | 10 |
| | [μm] | | | | | | |
| | Time required for | ≦1 | ≦1 | ≦1 | ≦1 | ≦1 | ≦1 |
| | drying [sec] | | | | | | |
| Laser | Type | YLF laser | YLF laser | YLF laser | YLF laser | YLF laser | YLF laser |
| light | Wavelength [nm] | 1053 | 1053 | 1053 | 1053 | 1053 | 1053 |
| | Intensity [J/cm² · pulse] | 4.8 | 4.8 | 4.8 | 4.8 | 4.8 | 4.8 |

| | | | | | | |
|---|---|---|---|---|---|---|
| Formation of recess | Exist | Exist | Exist | Exist | Exist | Exist |
| Width of recess [μm] | 32 | 52 | 50 | 38 | 41 | 39 |
| Depth of recess [μm] | 100 | 14 | 80 | 102 | 104 | 98 |

*1 Roughness of a surface on a side where a laser light is emitted.

From Table 1, it can be understood that, according to the laser processing method for the transparent material of the present invention, it is possible to process transparent materials having various characteristics by using the laser light with a high accuracy, while a recess having a desired depth and width cannot be obtained in Comparative Examples 1 through 3.

### INDUSTRIAL APPLICABILITY

According to the laser processing method for a transparent material of the present invention, it is possible to process a surface to be processed of a transparent material with a high accuracy even if the transparent material has a rear surface with large roughness or has defects therein.

### EXPLANATION OF REFERENCE CHARACTERS

1A Transparent material
1B Transparent material
1C Transparent material
2A Surface to be processed
2B Surface to be processed
2C Surface to be processed
3 Laser light absorbing substance
4 Laser light
5 Recess
6 Defect
7 Recess
8B Rear surface
8C Rear surface

1. A laser processing method for processing a transparent material using a laser light, including:
attaching a laser light absorbing substance having an absorption coefficient for the laser light of 1 μm⁻¹ or more to a surface to be processed of the transparent material, the laser light having an oscillation wavelength in a range of 193 to 11000 nm, and the transparent material having an absorption coefficient for the laser light of 1 cm⁻¹ or lower; and,
emitting the laser light from a front surface side of the laser light absorbing substance attached to the transparent material to process the surface to be processed of the transparent material.

2. The laser processing method for a transparent material according to claim 1, wherein
the transparent material is formed by quartz, calcium fluoride, silicon carbide, sapphire, alumina or diamond.

3. The laser processing method for a transparent material according to claim 1 or 2, wherein
the laser light absorbing substance is a colored ink.
